(19) United States
(12) Patent Application Publication
(10) Pub. No.: US 2012/0113545 A1
(43) Pub. Date: May 10, 2012

(54) Motor and recording disk drive including the same

(75) Inventor: Jin San Kim, Suwon (KR)

(73) Assignee: SAMSUNG ELECTRO-MECHANICS CO., LTD., Suwon (KR)

(21) Appl. No.: 13/373,153

(22) Filed: Nov. 7, 2011

(30) Foreign Application Priority Data
Nov. 9, 2010 (KR) 10-2010-0110929

(51) Int. Cl. H02K 7/08; G11B 17/34; G11B 5/54

(52) U.S. Cl. 360/97.11; 310/90; G9B/5.181; G9B/17.062

(57) ABSTRACT

There is provided with a motor, including: a rotating member coupled with a shaft and rotating in connection with the shaft; a stationary member having the shaft inserted therein to support the shaft and having a convex part formed to be protruded from the outside surface thereof; and a wall part protruding from one surface of the rotating member to allow oil to be sealed between the rotating member and the stationary member, and including a concave part having a concave groove formed at a position corresponding to the convex part.

### CROSS-REFERENCE TO RELATED APPLICATIONS

This application claims the priority of Korean Patent Application No. 10-2010-0110929 filed on Nov. 9, 2010, in the Korean Intellectual Property Office, the disclosure of which is incorporated herein by reference.

### BACKGROUND OF THE INVENTION

1. Field of the Invention

The present invention relates to a motor and a recording disk drive including the same, and more particularly, to a motor including a fluid dynamic pressure bearing assembly and a recording disk drive including the same.

2. Description of the Related Art

One of various types of information storage devices, a hard disk drive (HDD) is a device that uses a read/write head to reproduce data stored on a disk or to record data thereon.

The hard disk drive requires a disk drive capable of driving a disk. A small spindle motor is used for the disk driving device.

The small spindle motor uses a fluid dynamic pressure bearing assembly. In the fluid dynamic pressure bearing assembly, oil is filled between a rotating member, i.e., a shaft, and a stationary member, i.e., a sleeve. The shaft is supported by fluid pressure generated by the oil.

In addition, the oil filled between the rotating member and the stationary member of the spindle motor is sealed by using a capillary phenomenon and the surface tension of oil. The amount of oil, the interfacial position of oil, and the like, are important factors influencing the characteristics of the motor.

That is, when the amount of oil within the spindle motor is reduced at a level lower than a normal level of oil due to various factors, such as the evaporation and leakage of oil, or the like, bubbles may be introduced from the outside and friction between the rotating member and the stationary member increased, such that securing a levitation force for rotation is difficult, thereby causing the rotation characteristics of the rotating member to be deteriorated.

Further, the oil may escape from a normal oil interface by an excessive injection of oil, a reduction in oil filling volume, and oil expansion according to the increase in temperature due to the rotation of the rotating member, which may pollute a disk storing data to thereby cause the characteristics of a spindle motor to be deteriorated.

Therefore, in order to improve the performance of a hard disk drive (HDD) adopting the spindle motor and maximize the lifespan thereof, research into an oil sealing structure is required.

### SUMMARY OF THE INVENTION

An aspect of the present invention provides a motor capable of preventing the occurrence of oil leakage to prevent noise, vibrations, and non-repeatable runout (NRRO) from being generated during the rotation of rotating members and improving performance and lifespan of the motor by allowing the motor to be driven through the use of low current, and a recording disk drive including the same.

According to an aspect of the present invention, there is provided a motor, including: a rotating member coupled with a shaft and rotating in connection with the shaft; a stationary member having the shaft inserted therein to support the shaft and having a convex part formed to be protruded from the outside surface thereof; and a wall part protruding from one surface of the rotating member to allow oil to be sealed between the rotating member and the stationary member, and including a concave part having a concave groove formed at a position corresponding to the convex part.

The convex part may be formed on an outside surface of the stationary member, and the convex part may include a first convex inclined part formed in such a manner that a diameter of the stationary member is increased, a convex extending part formed to be extended downwardly in an axial direction from an end of the first convex inclined part, and a second convex inclined part formed in such a manner that a diameter of the stationary member is reduced from an end of the convex extending part.

The concave part may be formed to be rounded.

The concave part may include a first concave inclined part formed in such a manner that a diameter of an inside surface of the wall part is increased, a concave extending part formed to be extended downwardly in an axial direction from an end of the first concave inclined part, and a second concave inclined part formed in such a manner that the diameter of the inside surface of the wall part is reduced from an end of the concave extending part.

The convex part may be formed to be rounded.

The convex part may include a first convex inclined part formed in such a manner that a diameter of the stationary member is increased, a convex extending part formed to be extended downwardly in an axial direction from an end of the first convex inclined part, and a second convex inclined part formed in such a manner that a diameter of the stationary member is reduced from an end of the convex extending part, and the concave part may include a first concave inclined part formed in such a manner that a diameter of an inside surface of the wall part is increased, a concave extending part formed to be extended downwardly in the axial direction from an end of the first concave inclined part, and a second concave inclined part formed in such a manner that the diameter of the inside surface of the wall part is reduced from an end of the concave extending part.

At least one of an interval between an outside surface of the first convex inclined part and an inside surface of the first concave inclined part, an interval between the first convex inclined part and the first concave inclined part, an interval between the convex extending part and the concave extending part, and an interval between the second convex inclined part and the second concave inclined part may be constant.

One end of the first concave inclined part may be disposed at a higher position than one end of the first convex inclined part and the other end of the first concave inclined part is disposed at a lower position than the other end of the first convex inclined part.

The top portions of the first convex inclined part and the first concave inclined part may be provided with an oil interface.

The wall part may be formed along the outside surface of the stationary member, the concave part may be formed along the inside surface of the wall part, and the convex part may be formed to correspond to the concave part.

According to another aspect of the present invention, there is provided with a motor, including: a hub coupled with a shaft and rotating in connection with the shaft; a sleeve having the shaft inserted therein and supporting the shaft; a base member coupled with the sleeve and including a core around which a coil is wound, for generating a rotation driving force; a wall part formed to be protruded from one surface of the hub and including a concave part having a concave groove formed therein, wherein oil is sealed between the outside surface of the sleeve and the wall part; and a convex part formed to be protruded on one surface of the sleeve corresponding to the concave part and allowing for reducing energy of oil, wherein the oil is leaked between the convex part and the concave part.

The convex part may be formed on an outside surface of the sleeve, and the convex part may include a first convex inclined part formed in such a manner that a diameter of the sleeve is increased, a convex extending part formed to be extended downwardly in an axial direction from an end of the first convex inclined part, and a second convex inclined part formed in such a manner that a diameter of the sleeve is reduced from an end of the convex extending part.

The concave part may be formed to be rounded.

The concave part may include a first concave inclined part formed in such a manner that a diameter of an inside surface of the wall part is increased, a concave extending part formed to be extended downwardly in an axial direction from an end of the first concave inclined part, and a second concave inclined part formed in such a manner that the diameter of the inside surface of the wall part is reduced from an end of the concave extending part.

The convex part may be formed to be rounded.

The convex part may include a first convex inclined part formed in such a manner that a diameter of the sleeve is increased, a convex extending part formed to be extended downwardly in an axial direction from an end of the first convex inclined part, and a second convex inclined part formed in such a manner that a diameter of the sleeve is reduced from an end of the convex extending part, and the concave part may include a first concave inclined part formed in such a manner that a diameter of an inside surface of the wall part is increased, a concave extending part formed to be extended downwardly in the axial direction from an end of the first concave inclined part, and a second concave inclined part formed in such a manner that the diameter of the inside surface of the wall part is reduced from an end of the concave extending part.

At least one of an interval between an outside surface of the first convex inclined part and an inside surface of the first concave inclined part, an interval between the first convex inclined part and the first concave inclined part, an interval between the convex extending part and the concave extending part, and an interval between the second convex inclined part and the second concave inclined part may be constant.

One end of the first concave inclined part may be disposed at a higher position than one end of the first convex inclined part and the other end of the first concave inclined part may be disposed at a lower position than the other end of the first convex inclined part.

The top portions of the first convex inclined part and the first concave inclined part may be provided with an oil interface.

According to another aspect of the present invention, there is provided a recording disk drive, including: a motor of any one of claims 1 to 19, rotating a recording disk; a head transfer unit transferring a head detecting information of the recording disk mounted on the motor to the recording disk; and a housing receiving the motor and the head transfer unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a motor according to an exemplary embodiment of the present invention;

FIG. 2A is a cut-away perspective view schematically showing a hub provided in a motor according to an exemplary embodiment of the present invention, and FIG. 2B is an exterior perspective view schematically showing a sleeve provided in a motor according to an exemplary embodiment of the present invention;

FIG. 3 is an enlarged cross-sectional view of part A of FIG. 1;

FIG. 4 is an enlarged cross-sectional view of A of FIG. 1 showing a movement of a hub when impact is applied to a motor according to an exemplary embodiment of the present invention;

FIGS. 5 and 6 are enlarged cross-sectional views, each showing another example of part A of FIG. 1;

FIG. 7 is a cross-sectional view schematically showing a motor according to another exemplary embodiment of the present invention; and

FIG. 8 is a cross-sectional view schematically showing a recording disk drive including the motor according to the present invention.

### DETAILED DESCRIPTION OF THE PREFERRED EMBODIMENT

Hereinafter, exemplary embodiments of the present invention will be described in detail with reference to the accompanying drawings, which will fully convey the concept of the invention to those skilled in the art. Moreover, detailed descriptions related to well-known functions or configurations will be ruled out in order not to unnecessarily obscure the subject matter of the present invention. It is also noted that like reference numerals denote like elements in appreciating the drawings.

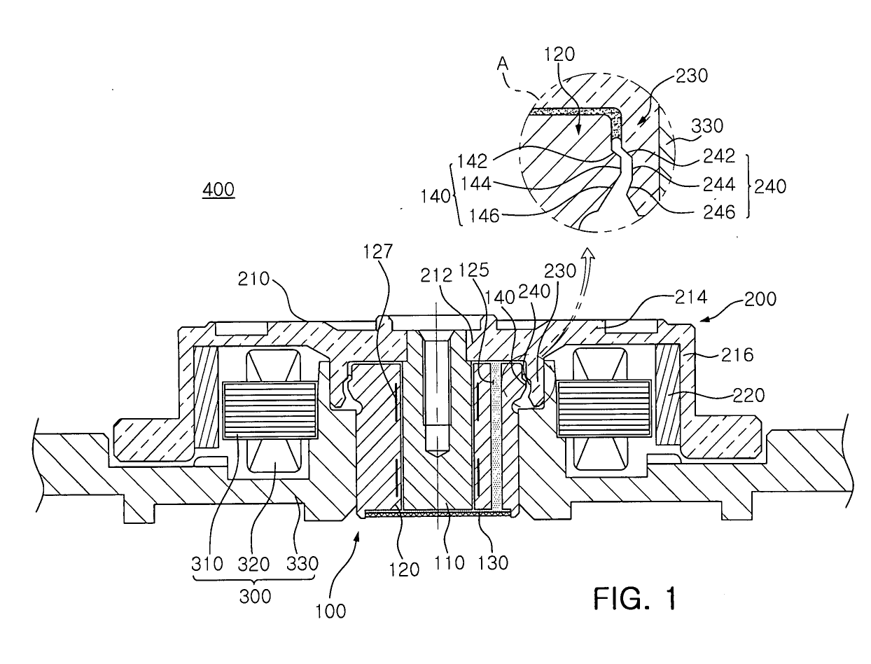

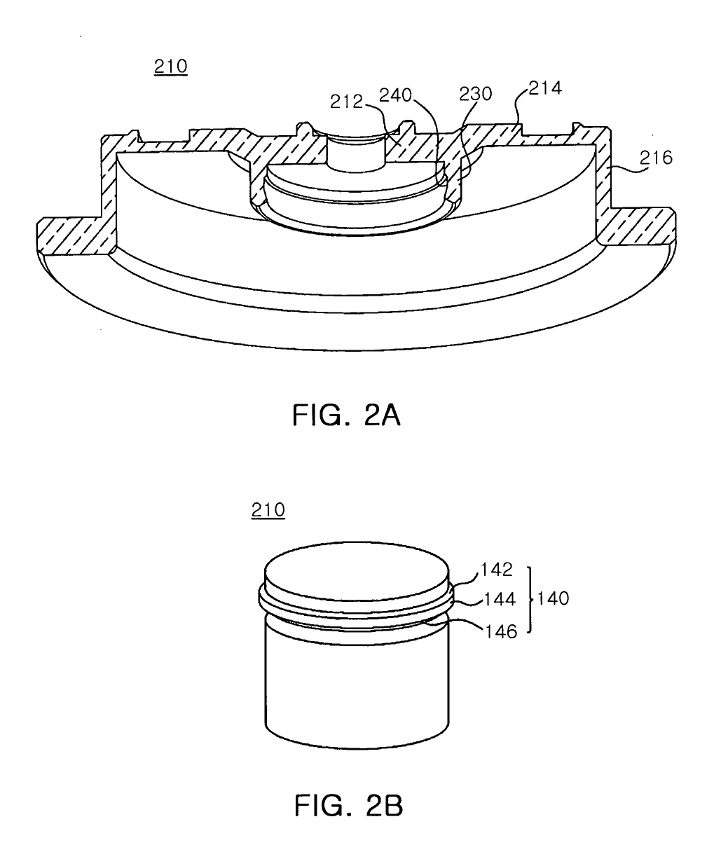

FIG. 1 is a cross-sectional view schematically showing a motor according to an exemplary embodiment of the present invention. FIG. 2A is a cut-away perspective view schematically showing a hub provided in a motor according to an exemplary embodiment of the present invention, and FIG. 2B is an exterior perspective view schematically showing a sleeve provided in a motor according to an exemplary embodiment of the present invention.

Referring to FIGS. 1, 2A and 2B, a motor 400 according to an exemplary embodiment of the present invention may be configured to include a fluid dynamic pressure bearing assembly 100 including a shaft 110 and a sleeve 120, a rotor 200 rotating in connection with the shaft 110, and a stator 300 including a core 310 around which a coil 320 is wound.

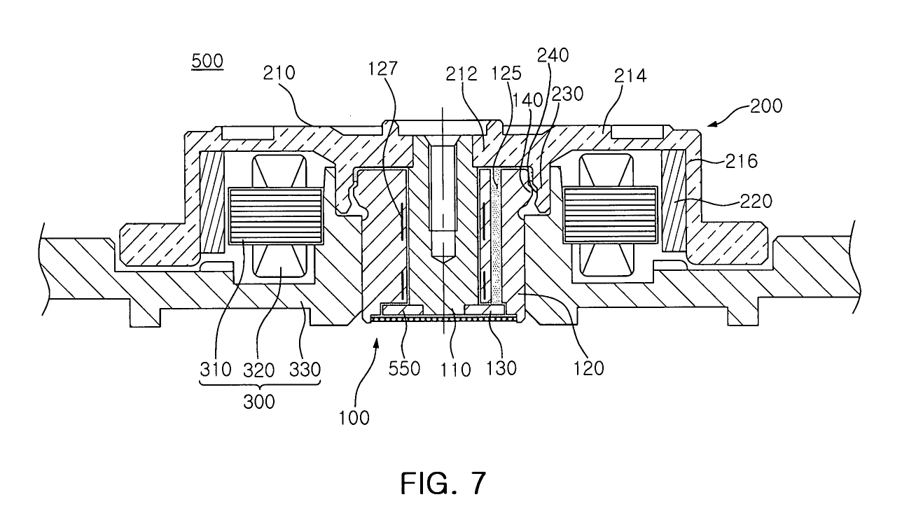

First, terms for directions are defined. When viewed in FIGS. 1 and 7, an axial direction refers to a vertical direction based on a shaft 110. A radial outside direction refers to an outer end direction of the hub 210, based on the shaft 110 while a radial inside direction refers to a central direction of the shaft 110, based on the outer end of the hub 210.

The sleeve 120 may refer to a stationary member coupled with a base member 330, into which the core 310 to be described below is inserted and fixed, and supporting the rotating member including the shaft 110.

The sleeve 120 may support the shaft 110 such that the upper end of the shaft 110 is upwardly protruded in the shaft direction and may be formed by forging Cu or Al or sintering Cu—Fe-based alloy powder or SUS-based powder.

In this configuration, the shaft 110 is inserted in such a manner as to have a small clearance between a shaft hole of the sleeve 120 and the shaft 110. The small clearance is filled with oil, so that the rotation of a rotor 200 may be smoothly supported by a radial dynamic pressure groove 127 formed in at least one of the outer diameter of the shaft 110 and the inner diameter of the sleeve 120.

The radial dynamic pressure groove 127 is formed in, the inside of the sleeve 120, which is the inside of the shaft hole of the sleeve 120, and forms a pressure so as to be biased to one side when the shaft 110 is rotated.

However, the formation of the radial dynamic pressure groove 127 is not limited to the case where it is provided in the inner side of the sleeve 120 as described above. The radial dynamic pressure groove 127 may also be provided at the outer diameter portion of the shaft 110 and may not be limited to the number thereof.

The radial dynamic pressure groove 127 may be any one of a herringbone shape, a spiral shape, and a helix shape. However, the radial dynamic pressure groove 127 is not limited to the shape thereof, as long as it may generate a radial dynamic pressure.

The outside surface of the sleeve 120 may be provided with a convex part 140 formed to be protruded to prevent oil leakage. The convex part 140 may serve as a resistor reducing the kinetic energy of oil leaked between the convex part 140 and a concave part 240, together with the concave part 240 to be described below.

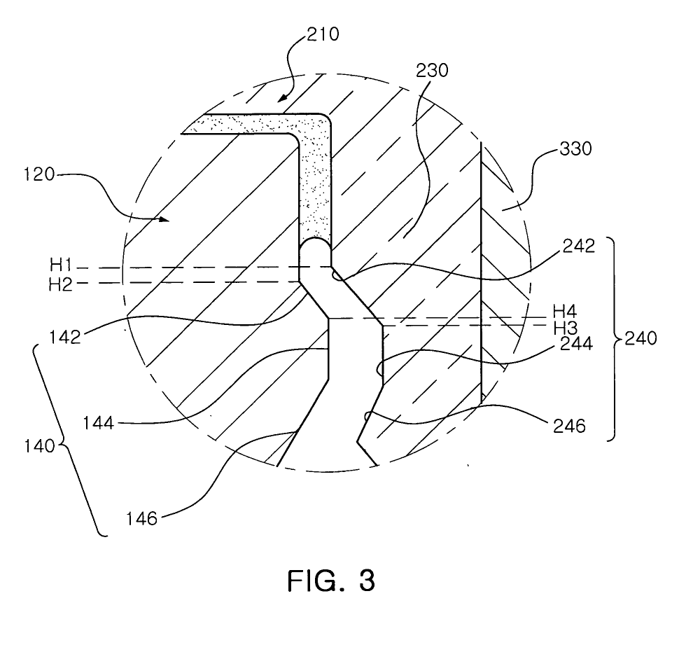

The convex part 140 and the concave part 240 will be described with reference to FIGS. 3 to 6.

The sleeve 120 is provided with a circulation hole 125 formed to communicate the top portion and the bottom portion of the sleeve 120 with each other, such that the pressure of oil in the fluid dynamic pressure bearing assembly 100 may be dispersed to maintain the balance thereof and bubbles, or the like, existing in the fluid dynamic pressure bearing assembly 100 may be discharged through circulation.

In addition, a cover plate 140 may be coupled with the sleeve 120 downwardly in the shaft direction of the sleeve 120, while having a clearance maintained therebetween, which receives oil. The cover plate 140 receives oil in the clearance between the cover plate 140 and the sleeve 120 to thereby being capable of serving as a bearing supporting the bottom surface of the shaft 110.

The rotor 200 is a rotation structure rotatably provided with respect to the stator 300 to be described below and may be provided with the hub 210 having an annular ring magnet 220 provided at the inner peripheral surface thereof, which corresponds to the core 310 to be described later, at a predetermined distance.

In other words, the hub 210 may be a rotating member that is coupled with the top side of the shaft 110 to be rotated in connection with the shaft 110.

The magnet 220 may be a permanent magnet generating a predetermined strength of magnetic force by alternately magnetizing an N pole and an S pole in a circumferential direction thereof.

Further, the hub 210 may include a first cylindrical wall part 212 fixed to the top end of the shaft 110, a disk part 214 formed to be extended to the radial outside from the end of the first cylindrical wall part 212, and a second cylindrical wall part 216 protruded downwardly from the radial outside end of the disk plate 214. The inner peripheral surface of the second cylindrical wall part 216 may be coupled with the magnet 220.

Further, the hub 210 may seal oil between the hub 210 and the outside surface of the sleeve 120 and may include a wall part 230 formed to be extended downwardly to the axial direction in order to seal the oil.

That is, the wall part 230 may be formed to be protruded from one surface of the hub 210, which is the rotating member, the hub 210 to allow the oil to be sealed between the rotating member including the wall part 230 and the stationary member, the sleeve 120 and may be formed along the outside surface of the stationary member, the sleeve 120 in order to form the oil interface between the outside surface of the stationary member and the rotating member including the wall part 230.

In this case, the wall part 230 may be provided with the concave part 240 having a concave groove formed at a position corresponding to the convex part 140 formed on the sleeve 120.

As described above, the concave part 240 may serve as a resistor reducing the kinetic energy of oil leaked between the convex part 140 and the concave part 240, together with the convex part 140 formed on the sleeve 120.

The convex part 140 and the concave part 240 will be described with reference to FIGS. 3 to 6.

The stator 300 is a stationary member in which an insertion hole is formed and may refer to all of the fixed components other than rotating components, but it is considered to include the core 310, the coil 320, and the base member 330 for convenience of explanation.

The stator 300 may be a stationary structure that includes the coil 320 generating a predetermined strength of electromagnetic force when power is applied thereto and a plurality of cores 310 around which the coil 320 is wound.

The core 310 is fixedly disposed on the top portion of the base member 330 on which a printed circuit board (not shown) printed with pattern circuits is provided and a plurality of coil holes having a predetermined size may be formed, penetrating through the top surface of the base member 330 corresponding to the winding coil 320, in order to expose the winding coil 320 downwardly. The winding coil 320 is electrically connected to the printed circuit board (not shown) in order to supply external power thereto.

The base member 330 may be inserted with the core 310 to which the outer peripheral surface of the sleeve 120 is fixed and the coil 320 is wound. Meanwhile, the base member 330 and the sleeve 120 may be assembled by applying an adhesive to the inner surface of the base member 230 or the outside surface of the sleeve 120.

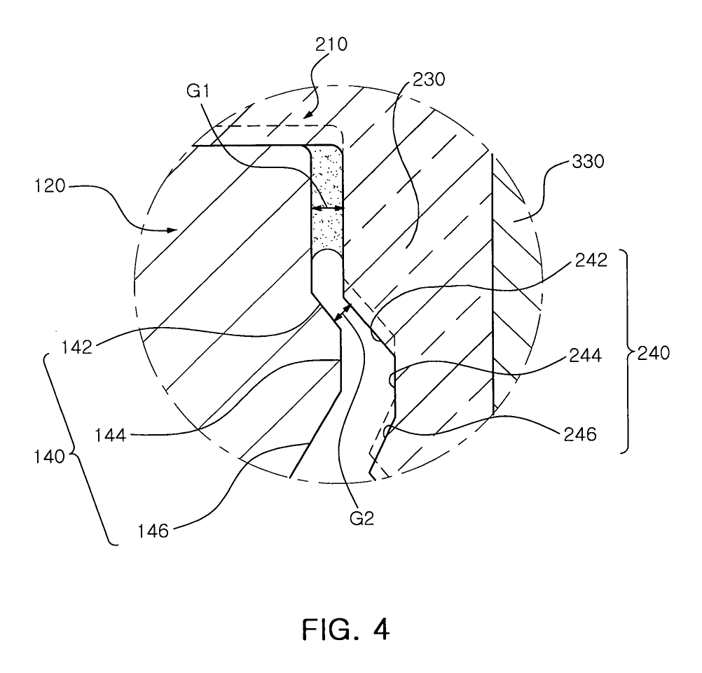

FIG. 3 is an enlarged cross-sectional view of part A of FIG. 1. FIG. 4 is an enlarged cross-sectional view of A of FIG. 1 showing a movement of a hub when impact is applied to a motor according to an exemplary embodiment of the present invention.

Referring to FIG. 3, the stationary member, the sleeve 120 may be provided with the convex part 140 formed to be protruded from the outside surface thereof and the rotating member, the wall part 230 of the hub 210 may be provided with the concave part 240 having the concave groove formed at a position corresponding to the convex part 140.

The top space of the convex part 140 and the concave part 240 may be formed with the oil interface and the convex part 140 and the concave part 240 may serve as a resistor reducing the kinetic energy of oil when the oil is leaked between the convex part 140 and the concave part 240.

As the case in which the oil is leaked, there may be the excessive injection of oil, a reduction in oil filling volume due to impacts, and oil expansion according to the increase in temperature due to the rotation of the rotating member, i.e., the hub 210, the external impact, or the like. In this case, the oil is escaped the normal oil interface, such that it may be leaked between the convex part 140 and the concave part 240.

In this case, it is possible to prevent the oil from being leaked to the outside by reducing the kinetic energy of oil due to the convex part 140 and the concave part 240, which will be described below.

The convex part 140 may be configured to include a first convex inclined part 142 formed in order to increase the diameter of the stationary member, the sleeve 120, a convex extending part 144 formed to be extended downwardly to the axial direction from the end of the first convex inclined part 142, and a second convex inclined part 146 formed in order to reduce the diameter of the sleeve 120 from the end of the block extending part 144.

In addition, the concave part 240 may include a first concave inclined part 242 formed to correspond to the convex part 140 in such a manner that the diameter of the inside surface of the wall part 230 is increased, a concave extending part 244 formed to be extended downwardly in the axial direction from the end of the first concave inclined part 242, and a second concave inclined part 246 formed in such a manner that the diameter of the inside of the wall part 230 is reduced from the end of the concave extending part 244.

In other words, the first convex inclined part 142, the block extending part 144, and the second convex inclined part 146 forming the convex part 140 may correspond to the first concave inclined part 242, the concave extending part 244, and the second concave inclined part 246 forming the concave part 240.

In this case, at least one of an interval between the outside surface of the first convex inclined part 142 and the inside surface of the first concave inclined part 242, an interval between the first convex inclined part 142 and the first concave inclined part 242, an interval between the convex extending part 144 and the concave extending part 244, and an interval between the second convex inclined part 146 and the second concave inclined part 246 may be constant, wherein all of the intervals may be the same.

In addition, one end H1 of the first concave inclined part 242 may be disposed at a higher position than one end H2 of the first convex inclined part 142 and the other end H3 of the first concave inclined part 242 may be disposed at a lower position than the other end H4 of the first convex inclined part 142.

This is to maximize the reduction in the kinetic energy of oil by minimizing the interval between the first convex inclined part 142 and the first concave inclined part 242 when the rotating member, the hub 210 contacts the top surface of the stationary member, the sleeve 120 by the external impact, which will be described below.

Referring to FIG. 4, the rotating member, the hub 210 is inserted and coupled with the top surface of the stationary member, the sleeve 120 in such a manner as to have a clearance therebetween, wherein the oil may be filled in the clearance.

In addition, the top portions of the convex part 140 and the concave part 240 may be provided with the oil interface and the oil interface in a normal state may be disposed at the top portions of the convex part 140 and the concave part 240.

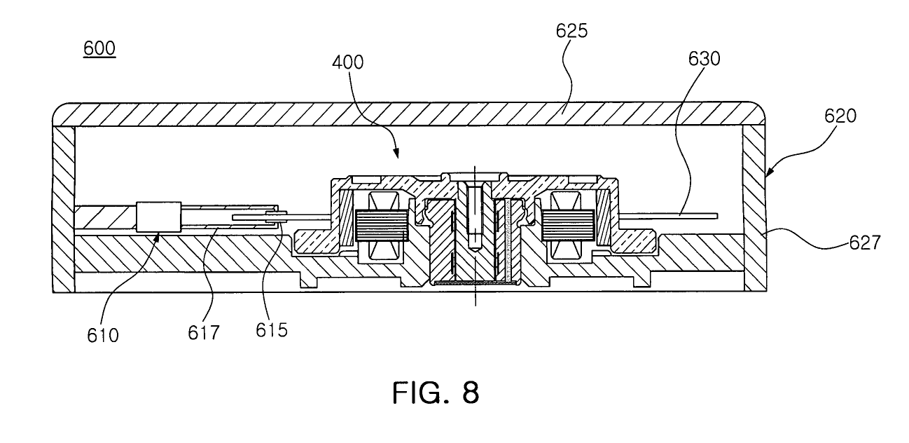

However, when the motor 400 and a recording disk drive 600 (see FIG. 8) including the same are applied with the external impact such as falling, or the like, the oil receives the kinetic energy due to the external impact and the rotating member, the hub 210 contacts the top surface of the stationary member, the sleeve 120.

In this case, the oil may be escaped from the normal oil interface and the oil may be introduced between the convex part 140 and the concave part 240.

In this case, the oil may be primarily introduced between the first convex inclined part 142 of the convex part 140 and the first concave inclined part 242 of the concave part 240. In this case, the oil comes into collision with the first convex inclined part 142, whereby, kinetic energy leaking the oil is reduced.

In addition, the oil having the kinetic energy reduced by the first convex inclined part 242 moves by bypassing a path thereof in the radial outside direction and the additional kinetic energy thereof is secondarily reduced by the friction loss generated on the surfaces of the first convex inclined part 142 and the first concave inclined part 242.

In addition, when the rotating member, the hub 210 contacts the stationary member, the top surface of the sleeve 120 due to the external impact, as shown in FIG. 4, a interval G2 between the first convex inclined part 142 of the convex part 140 and the first concave inclined part 242 of the concave part 240 is reduced. In other words, the interval G1 may be formed to be smaller than the interval G2 between the outside surface of the first convex inclined part 142 and the inside surface of the first concave inclined part 242.

Therefore, the path through which the oil passes is narrow, such that the kinetic energy of oil passing through the narrow path may be further reduced.

As described above, the motor 400 or the recording disk drive 600 including the same according to the exemplary embodiment of the present invention are applied with the external impact such as falling, or the like, the oil receives the kinetic energy due to the external impact, but the kinetic energy of oil may be minimized by three factors.

That is, the kinetic energy of oil primarily comes into collision with the convex part 140, such that the kinetic energy may be partially reduced and secondarily reduced while the oil moves by bypassing the path thereof in the radial outside direction.

In addition, the kinetic energy of oil is thirdly reduced while passing through a path having a narrow interval between the first convex inclined part 142 and the first concave inclined part 242, such that it is possible to previously prevent the oil from being leaked to the outside.

Further, the convex part 140 and the concave part 240 form a moving path of the oil in the radial outside direction, such that a space occupied by the oil is increased, whereby, there is only a fine change in oil when the oil is leaked to the outside.

In other words, the oil may be escaped from the normal oil interface due to the excessive injection of oil or, even though the normal oil interface is maintained, the oil may be escaped from the normal oil interface when the oil is expanded due to the increase in temperature.

In this case, the path through which the oil moves is formed at the radial outside, such that the space occupied by the oil is increased. As a result the overall moving distance of oil is very smaller, whereby it is possible to prevent the oil from being leaked to the outside.

As a result, the noise, the vibrations, and the non-repeatable runout (NRRO) occurring due to the oil leakage may be minimized, such that the lifespan of the motor 400 according to the exemplary embodiment of the present invention can be maximized.

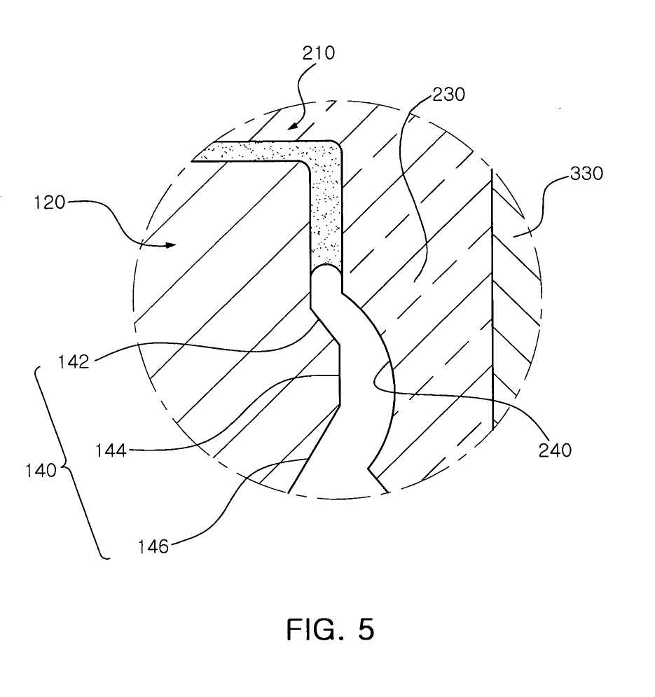

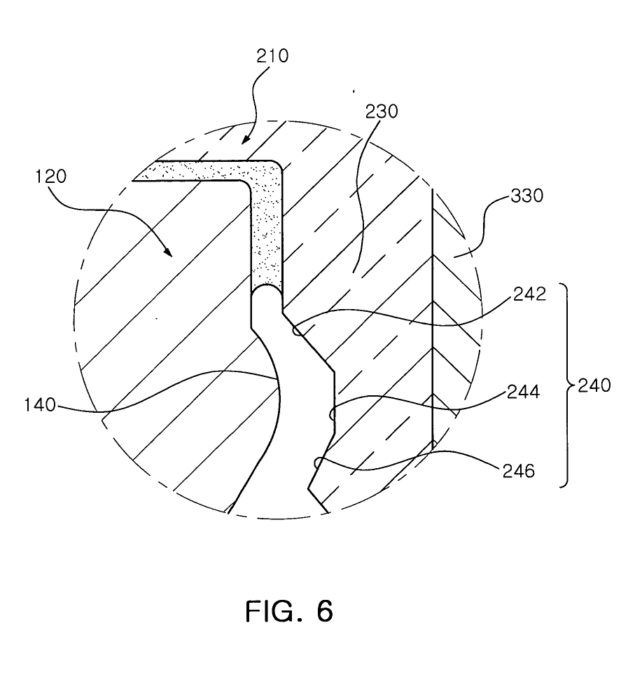

FIGS. 5 and 6 are enlarged cross-sectional views, each showing another example of A of FIG. 1 according to an exemplary embodiment of the present invention.

Referring to FIG. 5, the concave part 240 formed on the wall part 230 of the hub 210 which is the rotating member, may be formed to be rounded.

However, the convex part 140 formed on the stationary member, the sleeve 120 may be configured to include the first convex inclined part 142, the convex extending part 144, and the second convex inclined part 146 as described in the foregoing exemplary embodiments. The concave part 240 may be formed to be entirely rounded without discriminating a boundary.

Referring to FIG. 6, the convex part 140 formed on the outside surface of the stationary member, the sleeve 120 may be formed to be rounded.

However, the concave part 240 formed on the wall part 230 of the hub 210 which is the rotating member, may be configured to include the first concave inclined part 242, the concave extending part 244, and the second concave inclined part 246 as described in the foregoing exemplary embodiments. The convex part 140 may be formed to be entirely rounded without discriminating a boundary.

In this configuration, the top space of the convex part 140 and the concave part 240 may be provided with the oil interface and the convex part 140 and the concave part 240 may serve as a resistor reducing the kinetic energy of oil when the oil is leaked between the convex part 140 and the concave part 240.

That is, it is possible to prevent the oil from being leaked due to three factors described in the foregoing exemplary embodiment.

FIG. 7 is a cross-sectional view schematically showing the motor according to another exemplary embodiment of the present invention.

Referring to FIG. 7, a motor 500 according to another exemplary embodiment of the present invention has the same components and effects as the motor 400 according to the previous exemplary embodiment of the present invention and therefore, the description of other components other than a thrust plate 550 will be omitted.

The thrust plate 550 is disposed under the sleeve 120 and the center thereof is provided with a hole corresponding to the cross section of the shaft 110 so that the shaft 110 may be inserted into the hole.

In this configuration, the thrust plate 550 may be separately manufactured to be coupled with the shaft 110, but may be integrally formed with the shaft 110 from the beginning of manufacturing and may be rotated along the shaft 110 at the time of the rotary motion of the shaft 110.

The top surface of the bottom surface of the thrust plate 550 may be provided with the thrust dynamic pressure groove providing the thrust dynamic pressure to the shaft 110. The top surface of the thrust plate 550 may have the spiral shape and the bottom surface thereof may have a herringbone shape.

However, as described above, the thrust dynamic pressure groove formed on the top surface and the bottom surface of the thrust plate 550 may have the spiral shape and the herringbone shape, but the shape of the thrust dynamic pressure groove is not necessarily limited thereto. As a result, if the thrust dynamic pressure groove may provide the thrust dynamic pressure, the shape thereof is not limited.

FIG. 8 is a cross-sectional view schematically showing a recording disk drive including the motor according to the present invention.

Referring to FIG. 8, a recording disk drive 600 including the motor 400 according to the present invention is a hard disk drive and may be configured to include the motor 400, a head transfer unit 610, and a housing 620.

The motor 400 has all the above-mentioned features of the present invention and may mount a recording disk 630 thereon.

Further, FIG. 8 shows the motor 400 according to the exemplary embodiment of the present invention, but present invention is not limited thereto, and therefore, all the above-mentioned motors 400 and 500 may be applied.

The head transfer part 610 may transfer a head 615 detecting the information of the recording disk 630 mounted on the motor 400 to the surface of the recording disk to be detected.

In this case, the head 615 may be disposed on a supporting part 617 of the head transfer part 610.

The housing 620 may be configured to include a motor mount plate 627 and a top cover 625 shielding the top portion of the motor mount plate 627 in order to form the inner space receiving the motor 400 and the head transfer part 610.

As set forth above, the motors 400 and 500 according to the exemplary embodiments of the present invention include the convex part 140 formed on the outside surface of the stationary member, the sleeve 120 and the concave part 240 formed on the wall part 230 of the rotating member, the hub 210 to prevent the oil from being leaked due to the increase in temperature and the external impact, thereby improving the performance and lifespan of the motors 400 and 500 according to the exemplary embodiment of the present invention.

Further, according to the exemplary embodiments of the present invention, even in the case in which the oil is escaped from the normal oil interface due to the excessive injection of the oil, or the oil is escaped from the normal oil interface due to the oil expansion according to the increase in temperature even though the normal oil interface is maintained, since the path of the oil could be formed at the radial outside, thereby allowing for minimizing the overall moving distance of oil.

Therefore, according to the exemplary embodiment of the present invention, it is possible to effectively prevent the oil from being leaked to the outside.

As set forth above, the motor and the recording disk drive according to the exemplary embodiments of the present invention can prevent the oil leakage due to the increase in temperature and the external impact, thereby improving the performance of the motor.

In addition, according to the exemplary embodiments of the present invention the amount of storable oil is secured, thereby allowing for maximizing the lifespan of the motor.

While the present invention has been shown and described in connection with the exemplary embodiments, it will be apparent to those skilled in the art that modifications and variations can be made without departing from the spirit and scope of the invention as defined by the appended claims.

What is claimed is:

1. A motor, comprising:
a rotating member coupled with a shaft and rotating in connection with the shaft;
a stationary member having the shaft inserted therein to support the shaft and having a convex part formed to be protruded from the outside surface thereof; and
a wall part protruding from one surface of the rotating member to allow oil to be sealed between the rotating member and the stationary member, and including a concave part having a concave groove formed at a position corresponding to the convex part.

2. The motor of claim 1, wherein the convex part is formed on an outside surface of the stationary member, and
the convex part includes a first convex inclined part formed in such a manner that a diameter of the stationary member is increased, a convex extending part formed to be extended downwardly in an axial direction from an end of the first convex inclined part, and a second convex inclined part formed in such a manner that a diameter of the stationary member is reduced from an end of the convex extending part.

3. The motor of claim 2, wherein the concave part is formed to be rounded.

4. The motor of claim 1, wherein the concave part includes a first concave inclined part formed in such a manner that a diameter of an inside surface of the wall part is increased, a concave extending part formed to be extended downwardly in an axial direction from an end of the first concave inclined part, and a second concave inclined part formed in such a manner that the diameter of the inside surface of the wall part is reduced from an end of the concave extending part.

5. The motor of claim 4, wherein the convex part is formed to be rounded.

6. The motor of claim 1, wherein the convex part includes a first convex inclined part formed in such a manner that a diameter of the stationary member is increased, a convex extending part formed to be extended downwardly in an axial direction from an end of the first convex inclined part, and a second convex inclined part formed in such a manner that a diameter of the stationary member is reduced from an end of the convex extending part, and
the concave part includes a first concave inclined part formed in such a manner that a diameter of an inside surface of the wall part is increased, a concave extending part formed to be extended downwardly in the axial direction from an end of the first concave inclined part, and a second concave inclined part formed in such a manner that the diameter of the inside surface of the wall part is reduced from an end of the concave extending part.

7. The motor of claim 6, wherein at least one of an interval between an outside surface of the first convex inclined part and an inside surface of the first concave inclined part, an interval between the first convex inclined part and the first concave inclined part, an interval between the convex extending part and the concave extending part, and an interval between the second convex inclined part and the second concave inclined part is constant.

8. The motor of claim 6, wherein one end of the first concave inclined part is disposed at a higher position than one end of the first convex inclined part and the other end of the first concave inclined part is disposed at a lower position than the other end of the first convex inclined part.

9. The motor of claim 6, wherein the top portions of the first convex inclined part and the first concave inclined part are provided with an oil interface.

10. The motor of claim 1, wherein the wall part is formed along the outside surface of the stationary member, the concave part is formed along the inside surface of the wall part, and the convex part is formed to correspond to the concave part.

11. A motor, comprising:
a hub coupled with a shaft and rotating in connection with the shaft;
a sleeve having the shaft inserted therein and supporting the shaft;
a base member coupled with the sleeve and including a core around which a coil is wound, for generating a rotation driving force;
a wall part formed to be protruded from one surface of the hub and including a concave part having a concave groove formed therein, wherein oil is sealed between the outside surface of the sleeve and the wall part; and
a convex part formed to be protruded on one surface of the sleeve corresponding to the concave part and allowing for reducing energy of oil, wherein the oil is leaked between the convex part and the concave part.

12. The motor of claim 11, wherein the convex part is formed on an outside surface of the sleeve, and
the convex part includes a first convex inclined part formed in such a manner that a diameter of the sleeve is increased, a convex extending part formed to be extended downwardly in an axial direction from an end of the first convex inclined part, and a second convex inclined part formed in such a manner that a diameter of the sleeve is reduced from an end of the convex extending part.

13. The motor of claim 12, wherein the concave part is formed to be rounded.

14. The motor of claim 11, wherein the concave part includes a first concave inclined part formed in such a manner that a diameter of an inside surface of the wall part is increased, a concave extending part formed to be extended downwardly in an axial direction from an end of the first concave inclined part, and a second concave inclined part formed in such a manner that the diameter of the inside surface of the wall part is reduced from an end of the concave extending part.

15. The motor of claim 14, wherein the convex part is formed to be rounded.

16. The motor of claim 11, wherein the convex part includes a first convex inclined part formed in such a manner that a diameter of the sleeve is increased, a convex extending part formed to be extended downwardly in an axial direction from an end of the first convex inclined part, and a second convex inclined part formed in such a manner that a diameter of the sleeve is reduced from an end of the convex extending part, and
the concave part includes a first concave inclined part formed in such a manner that a diameter of an inside surface of the wall part is increased, a concave extending part formed to be extended downwardly in the axial direction from an end of the first concave inclined part, and a second concave inclined part formed in such a manner that the diameter of the inside surface of the wall part is reduced from an end of the concave extending part.

17. The motor of claim 16, wherein at least one of an interval between an outside surface of the first convex inclined part and an inside surface of the first concave inclined part, an interval between the first convex inclined part and the first concave inclined part, an interval between the convex extending part and the concave extending part, and an interval between the second convex inclined part and the second concave inclined part is constant.

18. The motor of claim 16, wherein one end of the first concave inclined part is disposed at a higher position than one end of the first convex inclined part and the other end of the first concave inclined part is disposed at a lower position than the other end of the first convex inclined part.

19. The motor of claim 16, wherein the top portions of the first convex inclined part and the first concave inclined part are provided with an oil interface.

20. A recording disk drive, comprising:
a motor of claim 1, rotating a recording disk;
a head transfer unit transferring a head detecting information of the recording disk mounted on the motor to the recording disk; and
a housing receiving the motor and the head transfer unit.
